(19) United States
(12) Patent Application Publication
(10) Pub. No.: US 2020/0319018 A1
(43) Pub. Date: Oct. 8, 2020

(54) DISTRIBUTED OPTICAL FIBER SENSING FOR SMART CITY APPLICATIONS

(71) Applicant: NEC Laboratories America, Inc., Princeton, NJ (US)

(72) Inventors: Ming-Fang HUANG, Princeton, NJ (US); Ting WANG, West Windsor, NJ (US)

(73) Assignee: NEC LABORATORIES AMERICA, INC, Princeton, NJ (US)

(21) Appl. No.: 16/839,686

(22) Filed: Apr. 3, 2020

Related U.S. Application Data
(60) Provisional application No. 62/829,712, filed on Apr. 5, 2019.

(51) Int. Cl. G01H 9/00; G01K 11/32; H04W 4/70; G06Q 50/26

(52) U.S. Cl. CPC G01H 9/004; G06Q 50/26; H04W 4/70; G01K 11/32

(57) ABSTRACT

Aspects of the present disclosure describe distributed optical fiber sensing for smart city applications in which distributed optical fiber sensing is integrated with a surveillance system into a single system such that the distributed sensing system may detect an event of interest and the surveillance system including cameras may be reoriented in response to verify and/or examine and/or acquire video of the event. Of particular advantage such distributed fiber sensing may include distributed acoustic sensing (DAS) for vibrational sensing and distributed temperature sensing (DTS) for temperature sensing. The integrated system employs shared optical fiber transport for the distributed sensing and the surveillance.

### CROSS REFERENCE

This disclosure claims the benefit of U.S. Provisional Patent Application Ser. No. 62/829,712 filed Apr. 5, 2019 the entire contents of which is incorporated by reference as if set forth at length herein.

### TECHNICAL FIELD

This disclosure relates generally to surveillance systems, method, and structures. More particularly, it describes contemporary video surveillance systems advantageously enhanced by distributed optical fiber sensing systems, methods, and structures and smart city applications developed therefrom.

### BACKGROUND

As is known in the surveillance arts, contemporary surveillance systems including cameras, controllers, and storage systems oftentimes employ optical fiber cable as a transmission media to provide for long distance transmission of surveillance video signals/data over long distance(s) at high bandwidth(s). Such optical fiber cable advantageously permits long distance(s) between the camera, controller, and storage elements while providing substantially little to no delay in transmission.

While optical fiber cable has proven quite useful for such applications, its primary function remains transmission of video signals between camera(s) and controller(s) and or storage systems.

### SUMMARY

An advance in the art is made according to aspects of the present disclosure directed to systems, methods, and structures providing distributed fiber optic sensing over optical fiber cable carrying surveillance video data thereby advantageously providing social sensing applications and the development of smart cities.

### BRIEF DESCRIPTION OF THE DRAWING

A more complete understanding of the present disclosure may be realized by reference to the accompanying drawing in which:

FIG. 1 shows a schematic diagram of an illustrative architecture of optical fiber sensing arrangement operating as part of a smart city environment according to aspects of the present disclosure;

FIG. 2(A) and FIG. 2(B) are schematic diagrams of illustrative new cable(s) that may be employed in the architecture of FIG. 1 according to aspects of the present disclosure; and

FIG. 3 is a schematic diagram of the illustrative architecture of FIG. 1 as part of an educational/school application according to aspects of the present disclosure.

The illustrative embodiments are described more fully by the Figures and detailed description. Embodiments according to this disclosure may, however, be embodied in various forms and are not limited to specific or illustrative embodiments described in the drawing and detailed description.

### DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

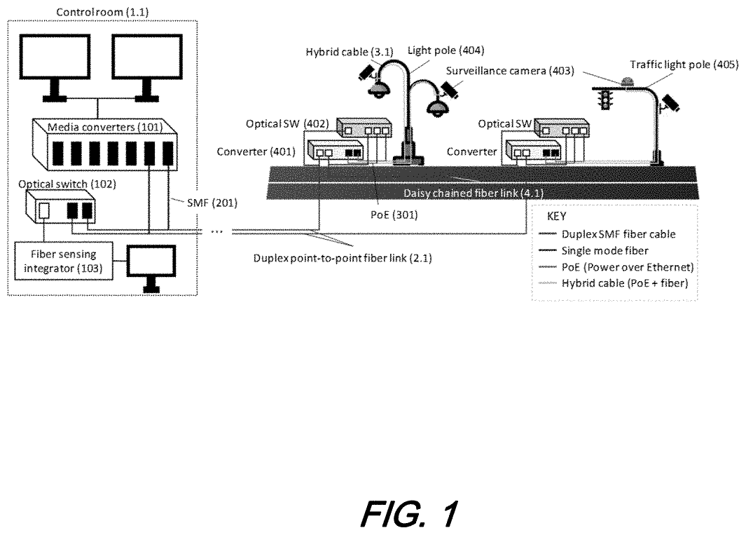

FIG. 1 shows a schematic diagram of an illustrative architecture of optical fiber sensing arrangement operating as part of a smart city environment according to aspects of the present disclosure. Those skilled in the art will recognize that this architecture includes aspects of current optical fiber-based surveillance system designs that include a point-to-point fiber link optically connecting a media converter 101 shown as located inside a control room 1.1 to a remote media converter 401 located in field. We note that—according to aspects of the present disclosure—the fiber link may advantageously provide distributed optical fiber sensor functionality in addition to conventional video communications noted previously.

When so configured, the optical fiber operates as a distributed optical fiber sensor providing social sensing data and resulting information along entire fiber infrastructure. As schematically illustrated in the figure, such infrastructure according to the present disclosure may include one or more optical switch 102, interrogator/integrator 103 which are shown as being positioned in a common control room 1.1.

While not explicit in FIG. 1, we note two key elements in this inventive architecture are SMF fiber cables 2.1 for point-to-point and daisy chained fiber link 4.1 and Hybrid cables 3.1 which are employed instead of a single fiber link and/or PoE (power over Ethernet) cables frequently used in current arrangements.

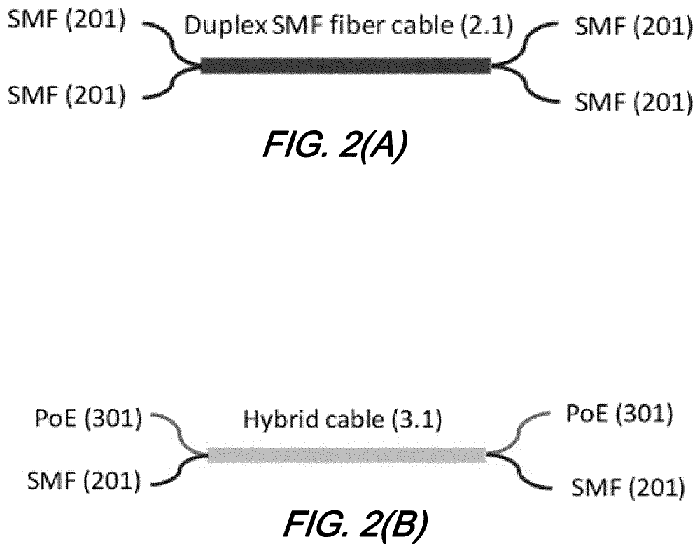

FIG. 2(A) and FIG. 2(B) are schematic diagrams of illustrative new cable(s) that may be employed in the architecture of FIG. 1 according to aspects of the present disclosure.

As shown in FIG. 2(A) figure, a duplex single mode fiber (SMF) fiber cable 2.1 includes two single mode fiber(s) (SMF 201, 202)—one used for video transmission from surveillance camera, the other one used for distributed fiber sensing.

Those skilled in the art will know and appreciate that typically, unshielded twisted pair, power-over-Ethernet type (PoE) cable are now widely used in the field to connect devices such as converters 401 and surveillance cameras 403, which provide video transmission bandwidth and electrical power to the cameras. In our inventive architecture, the hybrid cable 3.1 depicted in FIG. 2(B)—which includes one PoE 301 cable and one SMF 201—is employed instead of the traditional PoE cable. As a result, video transmission, electrical power to the camera, and social sensing applications via distributed fiber sensing operation are all advantageously provided.

With continued and simultaneous reference to FIG. 1, FIG. 2(A), and FIG. 2(B), during operation, a sensing interrogation signal (pulse) is generated by fiber sensing integrator 103. The generated signal is directed through optical switch 102, duplex point-to-point fiber link 2.1, field optical switch SW 402, single mode fiber (SMF 201) positioned inside hybrid cable 3.1, light pole 404 and finally to surveillance camera 403.

Since, according to aspects of the present disclosure, the entire fiber length in the architecture operationally performs as sensing media which can advantageously be used for social sensing—or other—applications.

By way of an illustrative example, if light poles 404—onto which are mounted surveillance cameras 403—are located in a parking lot, car horns and car security alarms can be advantageously detected by distributed vibration sensing and acoustic sensing techniques for parking lot security applications. When the light poles 404 or traffic light poles 405—onto which are mounted the surveillance cameras—are located instead on/near public roads, car crash events and other acoustic/vibratory events may likewise be detected by distributed optical fiber sensing technologies.

Still further, conditions of poles (such as light poles, traffic light poles, utility poles, etc., onto which surveillance cameras are mounted) may also be detected by distributed optical fiber sensing for pole health monitoring applications.

Finally, yet another variation to our architecture uses a daisy chained fiber link 4.1 to connect two converters in the field. As will be appreciated by those skilled in the art, such converters operate to convert electrical or other output signals from the cameras to optical signals for conveyance over the optical fiber. When so configured, a road surface temperature may be determined by distributed temperature sensing to track pavement condition(s). Advantageously, such operation permits the determination of an actual pavement temperature instead of estimating such temperatures—thereby permitting better estimates of road surface temperatures and resulting pavement distress that results.

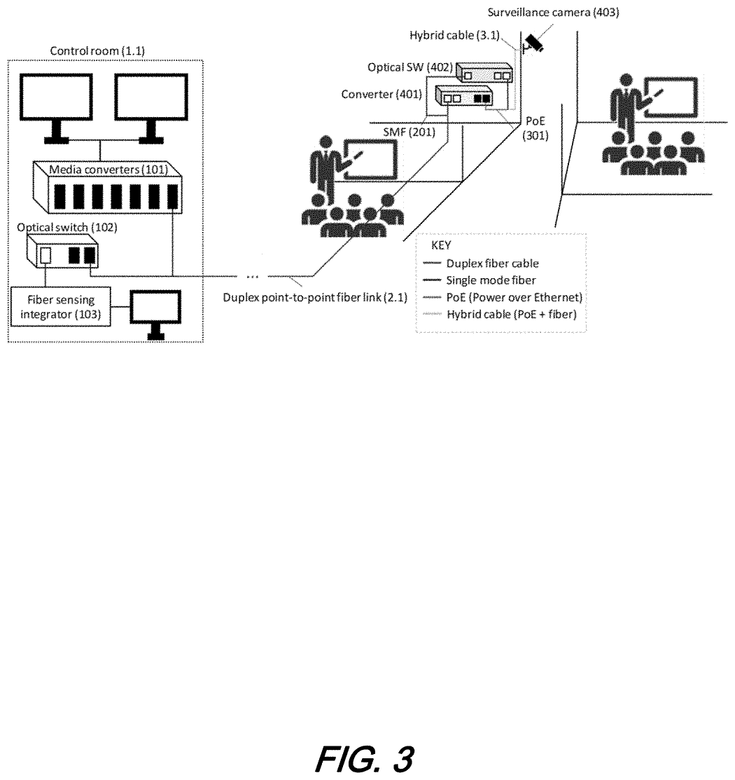

FIG. 3 is a schematic diagram of the illustrative architecture of FIG. 1 as part of an educational/school application according to aspects of the present disclosure. With reference now to that figure, one may observe yet another application of our inventive disclosure wherein distributed optical fiber sensing and surveillance video share optical fiber links.

In an arrangement like that of FIG. 2, an entire control and monitoring operation including control and monitoring systems are shown located in a control room 1.1 which can be—for example—a police station or a monitoring office up to 20-km away from a school. Instead of PoE cables, hybrid cables (3.1) is employed for video transmission and sensing applications.

Advantageously, the duplex point-to-point fiber link 2.1 can be located on walls, floors, ceilings, and can be used for person/intruder detection, temperature and structure monitoring, or safety/security considerations such as detecting unlawful violent events including shootings and/or bombings. Additionally, since our optical fiber sensing technology is integrated with surveillance systems, conveying triggered alarms to monitoring screens in real-time response to events is advantageously realized. In this illustrative example, the cameras can be controlled—or automatically zoom in to the targeted subjects and confirm events in real time. One illustrative summary of applications is listed in Table 1.

TABLE 1

| | Locations & Applications | | |
|---|---|---|---|
| Sensing | Public roads in | Parking lot | |
| technology | cities | security | Schools |
| Distributed | Car crash | Car horns | Gun shoot |
| acoustic | People screaming | Car security alarm | People screaming |
| sensing | Traffic light pole | People screaming | Structure health |
| (DAS) | health | Light pole health | Help surveillance |
| | Help surveillance | Help surveillance | cameras to locate |
| | cameras to locate | cameras to locate | events |
| | events | events | |
| Distributed | Road surface | | Building |
| temperature | temperature | | temperature |
| sensing | | | |
| (DTS) | | | |

While we have presented this disclosure using some specific examples, those skilled in the art will recognize that our teachings are not so limited. Accordingly, this disclosure should be only limited by the scope of the claims attached hereto.

1. An integrated distributed optical fiber sensing and video surveillance system comprising:
a length of optical fiber;
a distributed optical fiber sensing interrogator in optical communication with the length of optical fiber; and
a video surveillance system in optical communication with the length of optical fiber, the video surveillance system including one or more media converters and one or more surveillance cameras in communication with the one or more converters.

2. The integrated system of claim 1 further comprising:
one or more optical switches in optical communication with the length of optical fiber.

3. The integrated system of claim 2 wherein at least one of the one or more surveillance cameras are in communication with a length of hybrid cable, said hybrid cable including a power-over-Ethernet (PoE) type cable and a single mode optical fiber (SMF) cable, said hybrid cable connecting the at least one surveillance camera to an optical switch and a media converter via the SW′ and PoE cables, respectively.

4. The integrated system of claim 3 wherein the length of optical fiber comprises a length of duplex single mode fiber (SMF) cable, said duplex SW′ cable including two, individual single mode optical fibers.

5. A method of operating an integrated distributed optical fiber sensing and video surveillance system, said system comprising:
a length of optical fiber;
a distributed optical fiber sensing interrogator in optical communication with the length of optical fiber; and
a video surveillance system in optical communication with the length of optical fiber;
said method comprising:
simultaneously operating the distributed optical fiber sensing interrogator and the video surveillance system;
detecting an event of interest via the distributed optical fiber sensing; and
configuring the video surveillance system in response to the detected event.

6. The method of claim 5 wherein the video surveillance system includes one or more video surveillance cameras and the configuring of the video surveillance system in response to the detected event includes reorienting one or more of the video surveillance cameras.

7. The method of claim 6 wherein the distributed optical fiber sensing comprises sensing one or more characteristics selected from the group consisting of temperature (distributed temperature sensing—DTS) and mechanical vibrations (distributed acoustic sensing—DAS).

8. The method of claim 7 wherein the distributed optical fiber sensing senses infrastructure elements including one selected from the group consisting of buildings, roadways, and utility structures.

9. The method of claim 5 further comprising sending an alarm in response to the detected event.

10. The method of claim 9 wherein the interrogator generates optical pulses, introduces them into the optical fiber and receives reflected signals from the fiber, directs analysis of the reflected signals to determine sensing events.
